(19) United States
(12) Patent Application Publication
(10) Pub. No.: US 2007/0107514 A1
(43) Pub. Date: May 17, 2007

(54) Integrated sensor arrangement

(75) Inventors: Ulrich Sieben, Vorstetten (DE); Holger Klapproth, Freiburg (DE); Mirko Lehmann, Freiburg (DE)

Correspondence Address: THE WEBB LAW FIRM, P.C., 700 KOPPERS BUILDING, 436 SEVENTH AVENUE, PITTSBURGH, PA, 15219, US

(73) Assignees: Micronas GmbH, Freiburg i.Br. (DE); Micronas Holding GmbH, Freiburg i.Br. (DE)

(21) Appl. No.: 11/545,778

(22) Filed: Oct. 10, 2006

(30) Foreign Application Priority Data
Oct. 7, 2005 (DE) 10 2005 048 473.5
Aug. 15, 2006 (EP) 060 16 977.8

(51) Int. Cl. G01F 15/14

(52) U.S. Cl. 73/432.1

(57) ABSTRACT

An integrated sensor array has a substrates, at least one sensor element, and a signal processing device integrated in the substrate and connected or capable of being connected with the sensor elements. A layer having a measuring surface is capable of being detachably bonded to the substrate so that a signal emitted from the measuring surface is capable of being processed by the signal processing device when the layer is bonded to the substrate. The substrate has at least one feedthrough hole abutting with the layer, which feedthrough hole is connected or capable of being connected to a vacuum generating device in order to bond the layer to the substrate by suction.

The invention relates to an integrated sensor array comprising a substrate, at least one sensor element, and a signal processing device integrated in the substrate and connected or capable of being connected to the sensor element, wherein a layer having a measuring surface is capable of being detachably bonded to the substrate so that a signal emitted from the measuring surface is capable of being processed by the signal processing device when the layer is bonded to the substrate.

Such a sensor array is disclosed in DE 102 50 495 A1. It has a semiconductor chip as a substrate in which a plurality of optical sensor elements and a signal processing device are integrated. An area on the surface of the semiconductor chip is covered with an optically-transparent polymer tape on which receptors that are bond specific to a ligand that is to be detected are arranged. To detect a ligand bonded to a receptor, an optical beam is generated as a function of the bonding event, which is detected by the optical sensor elements. The polymer tape is mounted in an interchangeable cassette capable of being detachably bonded to the semiconductor chip and in which spools are provided to rewind or unwind the polymer tape. The polymer tape runs from a first spool to the semiconductor chip and then to a second spool. The polymer tape is longitudinally displaceable relative to the semiconductor chip by means of a transport device, wherein it is unwound from the first spool and rewound on the second spool. The polymer tape with the semiconductor chip located behind it abuts with an inner cavity of a measuring chamber that has an inlet opening and an outlet opening for an analyte that is to be tested and that contains the ligand. A seal is arranged between the polymer tape and the semiconductor chip, wherein the polymer tape is pressed against said seal by positive pressure in the inner cavity. The sensor array known to the prior art has proven particularly useful in practice because the semiconductor chip can be reused for other measurements after the measurement is completed. However, a disadvantage of the sensor array is that the generation of positive pressure requires a certain effort, especially if the measuring chamber is configured as an open trough or if the outlet opening is connected to an open container for receiving the tested analyte and the chemicals needed for the generation of the optical beam and if the conveyance of the analyte and/or the chemicals is not continuous.

The object is therefore to create a sensor array of the aforementioned type that is easy to manipulate.

This object is achieved in that the substrate has at least one feedthrough hole abutting with the layer and wherein said feedthrough hole is connected or capable of being connected to a vacuum-generating device in order to bond the layer to the substrate by suction.

In an expedient manner, a positive pressure can be generated on the side of the measuring surface-bearing layer opposite to the substrate so that the device is easy to manipulate. Nevertheless, the layer is pressed flatly against the substrate and immobilized thereon. If need be, the layer can serve as a seal, which seals an analyte to be tested that is located on the side of the layer opposite to the substrate against said substrate. Because the measuring surface-bearing layer is detachably bonded to the substrate, it can be easily replaced in order to reuse the substrate for another measurement after a measurement is completed. Preference is given to a semiconductor chip, especially a silicon chip, as the substrate. The at least one feedthrough hole can be formed in the substrate, for example, by drilling or by etching.

In a functional embodiment of the invention, the at least one feedthrough hole runs orthogonally to the surface of the substrate. The substrate can then be cost-effectively manufactured with the semiconductor manufacturing methods known per se.

The aforementioned objective can also be solved if the device has means for generating electrostatic and/or magnetic forces to immobilize the layer on the substrate. In particular, these means can consist of permanent magnets that are arranged on and/or adjacent to the substrate and/or on the back side of the substrate and aligned in a magnetic circuit with a ferromagnetic conducting zone on the layer bearing the measuring surface. However, the magnetic forces can also be generated by an electric current flowing through an inductor, which inductor can be arranged on, in, under, or adjacent to the substrate.

As a sensor element, the device preferably has at least one sensor, especially an amperometric, potentiometric, magnetic, optical, pressure and/or acceleration sensor, that is sensitive to a chemical and/or a physical quantity. In particular, the at least one sensor element can be an IDES, ISFET, and/or a Clark electrode. Electric signals, such as those emitted by living biological cells or biomolecules that are deposited on the measuring surface, can be detected by means of the electric contact element and transmitted via electric conduits to the signal processing device. Examples of biomolecules can include nucleic acids or their derivatives (DNA, RNA, PNA, LNA, oligonucleotides, plasmids, chromosomes), peptides, proteins (enzyme, protein, oligopeptides, cellular receptor proteins and their complexes, peptide hormones, antibodies and antibody fragments), carbohydrates and their derivatives, in particular glycosylized proteins and glycosides, fats, fatty acids and/or lipids. With the aid of the Clark electrode, the oxygen content in the zone of the measuring surface can be determined, which makes it possible to draw conclusions concerning the metabolic activity of the cell. The morphology of a cell can be measured with an IDES and the acidity of the cellular environment can be measured with an ISFET. However, other chemical analyses can also be performed with an IDES and/or an ISFET. Active and/or passive sensor elements can thus be provided. Supply and signal conduits can be fed vertically through the layer bearing the measuring surface and/or arranged laterally around said layer and attached with connectors to the substrate so that the signals from the sensor elements can be read out and/or the active sensor elements can be supplied with power.

In an advantageous embodiment of the invention, the layer has at least one receptor on the measuring surface that is bond-specific for a specific ligand, wherein at least one optical sensor is allocated to the receptor for the detection of an optical beam generated as a function of the bonding of the ligand to the receptor. The sensor array can then be used to detect and/or define the concentration of the ligand in an analyte that is to be tested.

In a preferred embodiment of the invention, the at least one sensor element is integrated in the layer capable of being detachably bonded to the substrate, wherein preference is given to electric contacts provided on the layer and counter-contacts provided on the substrate and coactive with the substrate for the transmission of a measuring signal from the sensor element to the signal processing device. With the aid of the sensors, an electric or an optical signal can be detected directly on the measuring surface and transmitted via the contacts and the counter-contacts to the signal processing device integrated in the substrate. It is also possible for the measuring signal to be wirelessly transmitted from the measuring surface to the substrate.

In another advantageous embodiment of the invention, the at least one sensor element is integrated in the substrate. In this case the sensor element can be configured as an optical sensor element that receives the optical beam through the measuring surface-bearing layer.

The layer bearing the measuring surface can have a film. It is even possible for the film to be composed of a synthetic material that has an electrical conductivity in a direction running orthogonally to the extension plane of the film greater than that in a direction running diagonally thereto. Contacts for the electrical connection of the film to the substrate can thus be manufactured very economically. Furthermore, depressions can be embossed in the surface of the film, for example, to make the film insensitive to contamination (lotus effect).

In another advantageous embodiment of the invention, the layer has a semiconductor substrate. This results in a sandwich construction in which several semiconductor chips are stacked above each other. The individual semiconductor chips can be manufactured with different technologies, for example, as bipolar silicon chips or as CMOS chips.

The layer can have at least one actuator element. This makes it possible, for example, to stimulate a biological cell immobilized on the measuring surface.

It is advantageous if the layer has an adjustable diffusion barrier for a liquid analyte capable of being deposited on said layer, wherein said diffusion barrier is adjacent to the at least one sensor element and/or the at least one receptor, and wherein said diffusion barrier is driveably connected to the actuator element. This makes it possible to influence the probability that a ligand contained in the analyte will bond to a receptor immobilized on the measuring surface. With a measuring surface on which several different ligands are immobilized and wherein said ligands are bond-specific to receptors contained in various concentrations in the analyte, the diffusion in the zone of the individual receptors can be controlled hereby so that a uniform modulation of the individual measuring points formed by the receptors is achieved.

In a preferred embodiment of the invention, several sensor elements are arranged adjacent to each other in matrix form, preferably in several rows and columns. With the aid of the sensor element, it is even possible to effect an “electronic adjustment” of the position of the layer bearing the measuring surface relative to the substrate when the surface area in which the sensor elements extend is greater than the measuring surface. With the aid of the signal processing device, the individual measuring signals from the sensor elements can be equated and compared with each other and/or a threshold value, in order to detect the sensor element(s) over which the measuring surface is positioned. If need be, the measuring signal of this sensor element can then be further processed in the signal processing device. The measuring surface-bearing layer can thus be positioned on the substrate with relatively large position tolerances, and the signal emitted from the measuring surface can nevertheless still be detected reliably by the sensor elements and transmitted to the signal processing device. Possible applications can be seen in the microtiter plate area. Here it is advantageous if the electrical contacts that come from the layer with the sensor elements are especially large (>500 μm).

It is advantageous if the feedthrough holes are always correspondingly aligned with a sensor element. It is thus even possible for the sensor elements to form an optical sensor array in which one pixel is always allocated to one feedthrough hole. The layer bearing the measuring surface can then be even more effectively immobilized on the substrate.

In a functional embodiment of the invention, the layer bearing the measuring surface is configured so that another layer can be detachably bonded thereon. The other layer can have characteristics similar to those of the first layer. The other layer can be a film, a semiconductor substrate, or a glass substrate. Various sensor elements can be arranged on the individual layers in order to detect different characteristics.

The individual layers and the substrate can be manufactured with the aid of different technologies, for example, a first layer can be configured as a CMOS semiconductor chip with sensory equipment and a signal processing device. A second layer can be a film with a depression. Such a depression cannot be produced on the CMOS semiconductor chip.

Another replaceable layer can be arranged between the layer with the measuring surface and the substrate, which layer can comprise sensor elements, feedthroughs for suction, and/or electric means for other types of adhesion capable of being reversed from both sides. The first-mentioned layer can be bonded to the other layer so that a channel with sensors is formed between the sensor bearing layers, through which channel liquids and/or gasses can be fed. Signal and power supply conduits can be fed to the substrate through and/or on the reversibly-bonded layers. The individual layers can also-be removed from the substrate at different times.

Sensor elements that transform their measurement values into signals that can be received by sensors on and/or in the substrate can also be arranged on the layer bearing the sensor element. This can be accomplished by the signals changing optically, magnetically, mechanically, and/or electrically, being set in motion, and/or emitting radio signals.

In an advantageous embodiment of the invention, the layer has at least one aperture in a zone opposite the sensor element. Measurements can then be taken through the aperture with the aid of the sensor element.

It is advantageous if the device has a measuring chamber having an inner cavity with at least one inlet opening and at least one outlet opening, which measuring chamber is capable of being detachably bonded to the substrate and/or the layer so that the latter abuts with the inner cavity of the measuring chamber. The inlet opening and possibly the outlet opening can then be connected to a fluidic system, by which a fluid that is to be analyzed and/or an active ingredient for influencing biocomponents contained in said fluid can be easily conducted into the measuring chamber. If need be, it is even possible for the inlet opening and/or the outlet opening to be fed through the substrate.

Clearly, more sensor elements can be provided on the substrate than power supply or signal conduits on the layer bearing the measuring surface. The power supply or signal conduits needed on the film for the actual signal infeeding or observation of the sensor elements can then be selected with regard to the type and position of the layer. The layer can be configured so that it gives information concerning its type and position on the substrate, so that an adaptive selection of the correct power supply and signal conduits for a control or regulator device is possible.

It should still be mentioned that in addition to the sensor element, a signal processing device can also be located on the film. The sensor array can then be used, for example, in a touch screen in which one would want to replace the surface if, for example, it gets scratched.

It is advantageous if an electrical energy source, especially a battery and/or a fuel cell, is arranged in and/or on the layer. The at least one sensor element, the optical sensor, an optical sensor for emitting an excitation beam and/or the signal processing device can be supplied with power via said energy source.

Exemplary embodiments of the invention are explained in greater detail in the following, with reference to the drawing, wherein:

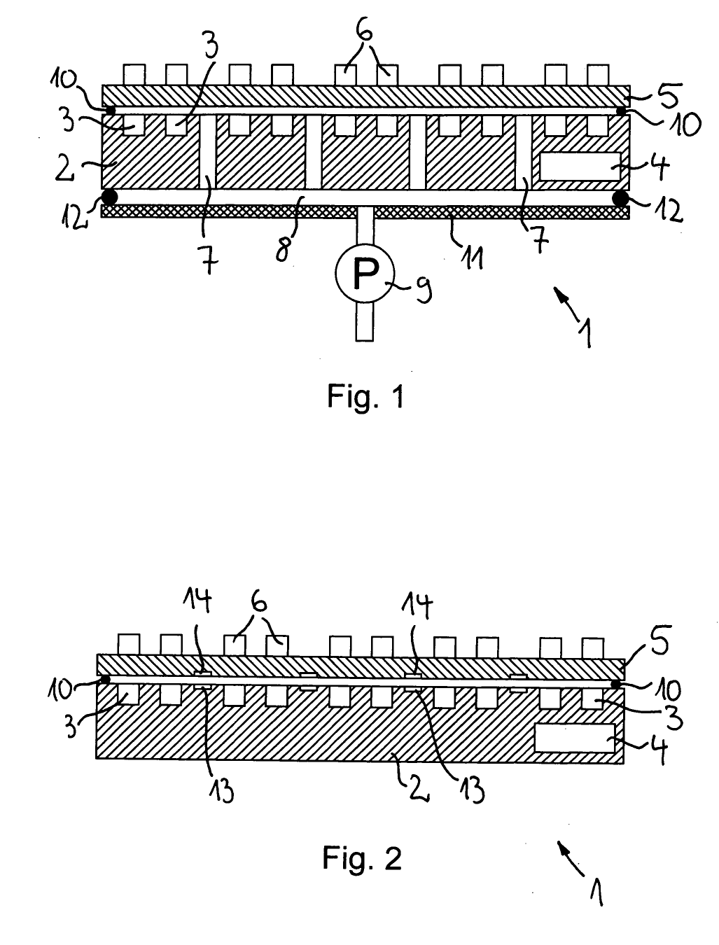

FIG. 1 shows a cross section of a sensor array that has a substrate to which a layer bearing the measuring surface can be bonded by suction,

FIG. 2 shows a cross section of a sensor array that has a substrate to which a layer bearing a measuring surface can be magnetically attached,

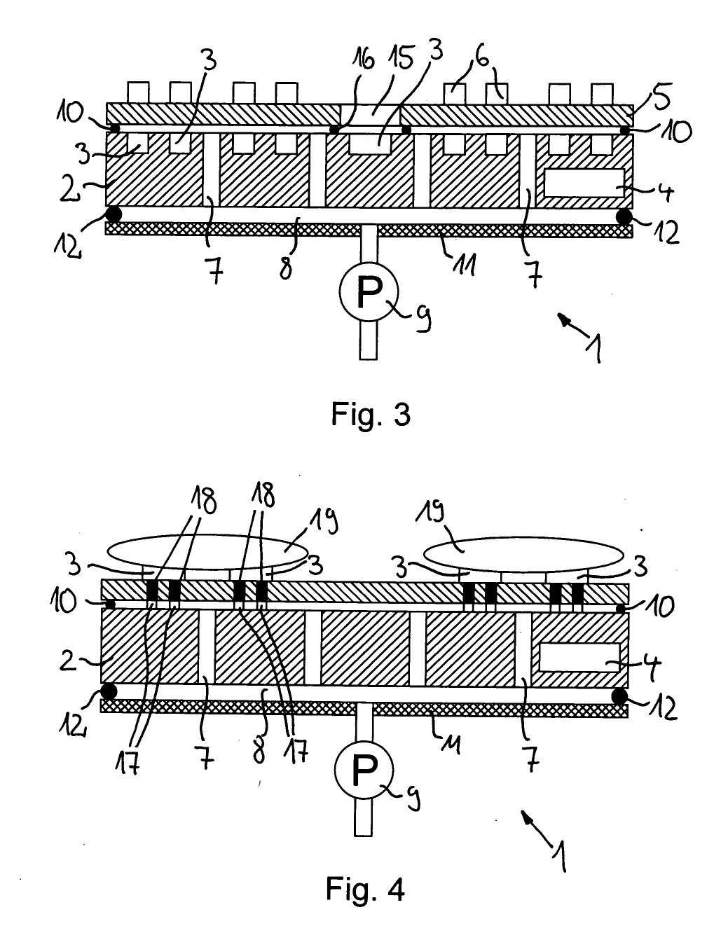

FIG. 3 shows an illustration similar to FIG. 1, wherein, however, the layer has an aperture,

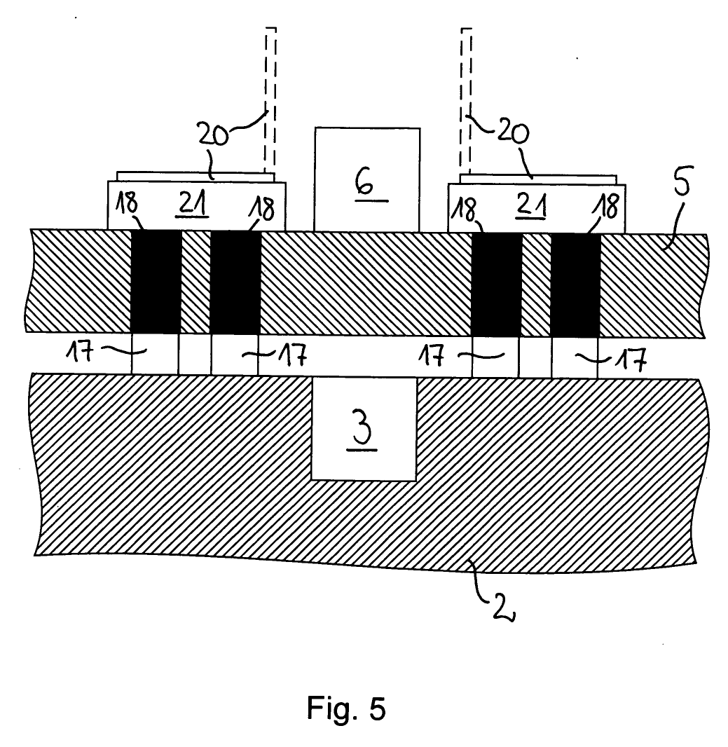

FIG. 4 shows a cross section of a sensor array on which a layer having electric contact elements can be replaceably fastened and

FIG. 5 shows a cross section of a sensor array in which adjustable diffusion barriers are arranged on the measuring surface.

An integrated sensor array designated in totality by 1 in FIG. 1 has a substrate 2 configured as a semiconductor chip in which several optical sensor elements 3 are monolithically integrated. The sensor elements 3 are arranged adjacent to each other in matrix form in several rows and columns. Furthermore, a signal processing device 4 is integrated in the substrate 2, which device is connected to the sensor elements 3 and power supply connections by means of conduits that are not represented in detail in the drawing.

A layer is arranged on the substrate 2 more or less parallel to the extension plane thereof, which layer consists of a film 5 with receptors 6 arranged thereon, wherein said receptors are always bond-specific for a specific ligand contained in an analyte that is to be tested and capable of being brought into contact with the measuring surface. The layer has a measuring surface on its front side opposite to the substrate 2, with which the receptors 6 abut. In a manner known per se, an optical beam can be generated as a function of the bonding of the ligand to the receptor 6, for example, if a receptor-ligand complex is marked with an optical marker, which, when irradiated with excitation radiation, emits a luminescent beam having a wavelength different from that of the excitation beam. The film 5 is transparent to the excitation beam. In FIG. 1, it can be discerned that the receptors 6 are always precisely aligned over a corresponding sensor element 3.

The layer formed from the film 5 and the receptors 6 is detachably bonded to the substrate 2 in such a way that, when the layer is bonded to the substrate 2, a signal emitted from the measuring surface can be received by the sensor elements 3 and detected with the signal processing device 4.

For the detachable bonding of the layer on the substrate 2, the latter has several laterally-spaced feedthrough holes 7 that penetrate the substrate more or less normally to its extension plane. A first end of each feedthrough hole 7 is always oriented to the back side of the layer and a second end of each feedthrough hole 7 is always connected via a manifold 8 to a suction line of a pump 9 commonly connected to said feedthrough holes 7. An exhaust line of the pump 9 vents to the atmosphere. In FIG. 1, it can be discerned that the feedthrough holes 7 are always arranged between the sensor elements and laterally spaced therefrom.

The film 5 is hermetically configured and sealed along its edge on the substrate 2 by means of a gasket 10. However, other embodiments are also conceivable in which the film 5 can lie directly on the surface of the substrate and be hermetically sealed thereon. In FIG. 1, a narrow space is arranged between the film 5 and the surface of the substrate 2, which extends parallel to the plane of the film 5 and by which the film 5 is separated from the substrate 2. The distance between the film 5 and the substrate 2 can be reduced to zero by applying negative pressure to the feedthrough holes 7.

The manifold 8 is formed between the back side of the substrate 2 opposite to the film 5 and a cover plate 11 covering said substrate 2. A gasket 12 is arranged between the substrate 2 and the cover plate 11, which gasket delimits the feedthrough holes 7. A vacuum conduit connected to the suction line of the pump 9 penetrates the cover plate 11.

To attach the film 5 to the substrate 2, the former is first positioned on the substrate so that the individual measuring points having the receptors 6 are always arranged over a corresponding sensor element 3 when the substrate 2 is viewed from above and the film 5 seals against the surface of the substrate 2. With the aid of the pump 9, a vacuum is then applied to the back side of the film 5 through the feedthrough holes 7, which presses the film 5 against the substrate 2.

In the exemplary embodiment shown in FIG. 2, a plurality of sensor elements 3 and a signal processing device 4 are likewise integrated in a semiconductor substrate 2. Said signal processing device is connected to the sensor element 3 and power supply connections via conduits, which are not shown in detail in the drawing.

A layer is detachably arranged on the substrate 2 more or less parallel to the extension plane thereof, which layer has a film 5 and a measuring surface, on which measuring surface a plurality of measuring points is provided, on which points receptors 6 that are bond-specific for a ligand are arranged.

In order to immobilize the film 5 on the substrate, means of generating magnetic forces are provided, which comprise permanent magnets 13 and coactive ferromagnetic particles 14. The permanent magnets 13 are arranged on an area of the surface of the substrate 2 facing the film 5 and the ferromagnetic particles 14 are embedded in the back side of the film 5. When the film 5 is positioned on the substrate, the ferromagnetic particles are permeated with the magnetic flux of the permanent magnets 13, whereby the film 5 is immobilized on the substrate 2 in a position in which the individual receptors 6 always align opposite a sensor element 3. It can also be discerned in FIG. 2 that the permanent magnets 13 are arranged between the sensor elements 3 and laterally spaced therefrom. When the film 5 is viewed from above, the ferromagnetic particles 14 are arranged between the receptors 6.

The construction of an exemplary embodiment of the sensor array 1 shown in FIG. 3 corresponds to a large extent to that of the exemplary embodiment in Fig.1, with the difference, however, that the film 5 has an aperture 15 behind which a sensor element 3 is arranged. The sensor element 3 can be, for example, a Clark electrode. The border zone of the film 5 delimiting the aperture 15 is hermetically sealed against the surface of the substrate 2 by a sealing element 16 encircling said aperture 15.

An exemplary embodiment of the sensor array shown in FIG. 4 has a semiconductor substrate 2 in which a signal processing device 4 is integrated, which is connected to electric counter-contacts 17 provided on an area of the surface of the substrate 2 facing the film 5 via conduits not shown in detail in the drawing. When the film 5 is positioned on the substrate 2, the counter-contacts 17 always contact a contact 18 penetrating the film 5. Sensor elements 3 are joined to the contacts 18. It can also be discerned in FIG. 4 that living biological cells 19 are immobilized on the sensor elements 3.

In order to detachably bond the film 5 onto the substrate 2, the latter has several feedthrough holes 7 laterally spaced from each other that penetrate said substrate 2 perpendicularly to its extension plane. A first end of each feedthrough hole 7 is always oriented to the back side of the film 5 and a second end of each feedthrough hole 7 is always connected via a manifold 8 to a suction line of a pump 9 commonly connected to one of said feedthrough holes 7.

In the exemplary embodiment shown in FIG. 5, the layer has adjustable diffusion barriers 20 adjacent to a receptor 6 for a liquid analyte capable of being deposited on said layer. The diffusion barriers 20 are always configured as flat elements that are driveably connected to an actuator element 21. By means of said actuator element 21, the diffusion barriers 20 can be pivoted from a resting position, in which they are arranged more or less parallel to the extension plane of the film 5, to an operation position represented by dashed lines in FIG. 5, in which their planes run more or less perpendicular to the extension plane of the film 5. In the operation position, the diffusion barriers 20 enclose the receptor 6 between themselves. The actuator elements 21 are electrically connected via electric contacts penetrating the film 5 to counter-contacts arranged on the substrate 2. The counter-contacts 17 are connected to the signal processing device 4 in order to control the actuator elements 21.

1. An integrated sensor array with a substrate, at least one sensor element, and a signal processing devices integrated in the substrate that is connected or capable of being connected to the sensor element, wherein a layer bearing a measuring surface is capable of being detachably bonded to the substrate in such a way that a signal emitted from the measuring surface is capable of being processed by the signal processing device when the layer is bonded to the substrate, characterized in that the substrate has at least one feedthrough hole abutting with the layer, which feedthrough hole is connected or capable of being connected to a vacuum generating device in order to bond the layer to the substrate by suction.

2. An integrated sensor array as defined in claim 1, characterized in that the at least one feedthrough hole runs orthogonally to the surface of the substrate.

3. (canceled)

4. An integrated sensor array as defined in claim 1, characterized in that as a sensor element, said sensor array has at least one sensor, especially an amperometric, potentiometric, magnetic, optical, pressure and/or acceleration sensor, that is sensitive to a chemical and/or a physical quantity.

5. An integrated sensor array as defined in claim 1, characterized in that the layer has at least one receptor on the measuring surface that is bond-specific for a specific ligand, and that at least one optical sensor is allocated to the receptor to detect an optical beam generated as a function of the bonding of the ligand to the receptor.

6. An integrated sensor array as defined in claim 1, characterized in that the at least one sensor element is integrated in the layer that is capable of being detachably bonded to the substrate, and that preference is given to electric contacts provided on the layer and counter-contacts provided on the substrate that are coactive with said substrate for the transmission of a measuring signal from the sensor element to the signal processing device.

7. An integrated sensor array as defined in claim 1, characterized in that the at least one sensor element is integrated in the substrate.

8. An integrated sensor array as defined in claim 1, characterized in that the layer has a film that is preferably transparent to a wavelength to which the optical sensor is sensitive.

9. An integrated sensor array as defined in claim 1, characterized in that the film is composed of a synthetic material that has an electrical conductivity in a direction running orthogonally to the extension plane of the film that is greater than that in a direction running diagonally thereto.

10. An integrated sensor array as defined in claim 1, characterized in that the layer has a semiconductor substrate.

11. An integrated sensor array as defined in claim 1, characterized in that the layer has at least one actuator element.

12. An integrated sensor arrays as defined in claim 1, characterized in that the layer has an adjustable diffusion barrier adjacent to the at least one sensor element and/or the at least one receptor for a liquid analyte capable of being deposited on the layer, and that the diffusion barrier is driveably connected to the actuator element.

13. An integrated sensor array as defined in claim 1, characterized in that several sensor elements are arranged next to one another in matrix form, preferably in several rows and columns.

14. An integrated sensor array as defined in claim 1, characterized in that the feedthrough holes are always correspondingly aligned with a sensor element-).

15. An integrated sensor array as defined in claim 1, characterized in that the layer is configured so that another layer can be detachably bonded thereon.

16. An integrated sensor array as defined in claim 1, characterized in that the layer has at least one aperture in an area opposite a sensor element.

17. An integrated sensor array as defined in claim 1, characterized in that said sensor array has a measuring chamber having an inner cavity with at least one inlet opening and at least one outlet opening and that is capable of being detachably bonded to the substrate and/or the layer so that the latter abuts with the inner cavity of said measuring chamber.

18. An integrated sensor array as defined in claim 1, characterized in that an electrical energy source, especially a battery and/or a fuel cell, is arranged in and/or on the layer.

19. An integrated sensor array with a substrate, at least one sensor element, and a signal processing device integrated in the substrate that is connected or capable of being connected to the sensor element, wherein a layer bearing a measuring surface is capable of being detachably bonded to the substrate in such a way that a signal emitted from the measuring surface is capable of being processed by the signal processing device when the layer is bonded to the substrate, characterized in that said sensor array has means of generating electrostatic and/or magnetic forces to immobilize the layer on the substrate.

20. An integrated sensor array as defined in claim 19, characterized in that the layer has at least one receptor on the measuring surface that is bond-specific for a specific ligand, and that at least one optical sensor is allocated to the receptor to detect an optical beam generated as a function of the bonding of the ligand to the receptor.

21. An integrated sensor array as defined in claim 19, characterized in that the at least one sensor element is integrated in the layer that is capable of being detachably bonded to the substrate, and that preference is given to electric contacts provided on the layer and counter-contacts provided on the substrate that are coactive with said substrate for the transmission of a measuring signal from the sensor element to the signal processing device.
